(19) United States
(12) Patent Application Publication
(10) Pub. No.: US 2021/0341773 A1
(43) Pub. Date: Nov. 4, 2021

(54) Method and apparatus for filling liquid crystal cells with a medium comprising at least one liquid crystalline material

(71) Applicant: Merck Patent GmbH, Darmstadt (DE)

(72) Inventors: Ronald VAN DEN HEUVEL, MH Veldhoven (NL); Martin BIJKER, KR Helmond (NL)

(73) Assignee: Merck Patent GmbH, Darmstadt (DE)

(21) Appl. No.: 17/271,242

(22) PCT Filed: Aug. 27, 2019
(86) PCT No.: PCT/EP2019/072752

§ 371 Date: Feb. 25, 2021

(30) Foreign Application Priority Data
Aug. 29, 2018 (EP) 18191490.4

(51) Int. Cl. G02F 1/1341; G02F 1/1339

(52) U.S. Cl. CPC G02F 1/1341; G02F 1/1339

(57) ABSTRACT

A method for filling liquid crystal cells (40) with a medium (30) comprising at least one liquid crystalline material. In the method at least one liquid crystal cell (40) is placed inside a vacuum chamber (12), the vacuum chamber is evacuated, at least one fill opening (46) of the at least one liquid crystal cell (40) is contacted with the medium, and the pressure in the vacuum chamber is raised causing the medium to fill the cavity inside the liquid crystal cell. A signal indicating the amount of oxygen remaining inside the vacuum chamber is provided by an oxygen sensor (20) mounted inside the vacuum chamber and completion of the evacuation of the vacuum chamber is determined based on said signal. Further disclosed is an apparatus for carrying out the process.

The invention relates to a method for filling liquid crystal cells with a medium comprising at least one liquid crystalline material, the liquid crystal cells comprising two substrates joined together with a peripheral seal so that a cavity is formed, wherein the liquid crystal cells comprise at least one fill opening. Further aspects of the invention relate to an apparatus for filling a liquid crystal cell with a medium comprising at least one liquid crystalline material and to the use of an oxygen sensor in a process for filling liquid crystal cells with a medium comprising at least one liquid crystalline material.

The review article by R. Baetens et al. “Properties, requirements and possibilities of smart windows for dynamic daylight and solar energy control in buildings: A state-of-the-art review”, Solar Energy Materials & Solar Cells 94 (2010) pages 87-105 describes tintable smart windows. Smart windows can make use of several technologies for modulating the transmittance of light such as devices based on electrochromism, liquid crystal devices and electrophoretic or suspended-particle devices. Liquid crystal based devices employ a change in the orientation of liquid crystal molecules between two conductive electrodes by applying an electric field which results in a change of their transmittance.

Known liquid crystal devices such as LCD display devices and liquid crystal based smart windows comprise two substrates with a liquid crystal layer sandwiched between the two substrates. In order to form a liquid crystal cell, the two substrates are arranged parallel to each other and the two substrates are joined by a peripheral seal such that a cavity between the two substrates is formed. At least one fill opening is arranged in the peripheral seal to allow filling of the cavity with a medium comprising at least one liquid crystalline material. After filling of the cavity, the at least one fill opening (or fill port) is sealed.

U.S. Pat. No. 4,099,550 discloses an apparatus for filling a liquid crystal cell of a liquid crystal display device. The liquid crystal cell is provided with a filling port and the apparatus comprises a vacuum tank and a holder for supporting a plurality of cells. The apparatus further comprises a holder for the liquid crystal which includes capillary passages for the liquid crystal. The vacuum tank is evacuated and the capillary passages are brought in contact with the filling ports of the cells. Subsequently, an inert gas is introduced into the vacuum tank thereby filling the liquid crystal into the cells through the filling ports.

U.S. Pat. No. 5,725,032 describes a method for filling a liquid crystal cell with liquid crystal. The method comprises the step of placing the cell having a cavity and inlet openings in its top and bottom edges in a vacuum chamber which encloses upper and lower liquid crystal supply members each having a liquid crystal impregnated yarn exposed through a slot therein. The vacuum chamber is evacuated, the liquid crystal supply members are brought into contact with the top and bottom inlet openings and the chamber is returned to an atmospheric pressure. Returning the chamber to atmospheric pressure causes liquid crystal to be sucked into the cavity through the inlet openings.

Liquid crystal devices intended to be used as smart windows are large devices and thus the volume of the cavity formed by the two substrates is large compared to the size of the fill openings. The gap size of the cavity of usually about 10 μm to 50 μm is small compared to the size of the fill openings which usually have a width of about 25 mm to 40 mm. When the liquid crystal cell is placed into a vacuum chamber and the vacuum chamber is evacuated, air trapped inside the cavity may only be released through the fill openings. While the vacuum chamber may be evacuated quickly, the speed of evacuation of the cavities is limited. There may be a significant amount of air remaining inside the cells even so the pressure in the vacuum chamber outside of the cavities would indicate sufficient evacuation. If filling of the cells is started to early, trapped air inside the cells may cause visible defects in the liquid crystal device.

In order to avoid such defects, it is common to continue evacuation for a certain amount of time even though a pressure sensor would indicate a sufficiently low pressure and thus completion of evacuation. This waiting time slows down the filling process.

It is an object of the invention to provide a method for filling liquid crystal cells with a medium comprising at least one liquid crystalline material wherein a sufficient evacuation can be determined and thus unnecessary wait times may be avoided.

A further object of the invention may be seen in providing a method for filling liquid crystal cells with a medium comprising at least one liquid crystalline material wherein the pressure inside the cavities is controlled.

A method for filling liquid crystal cells with a medium comprising at least one liquid crystalline material is proposed. The liquid crystal cells comprise two substrates joined together with a peripheral seal so that a cavity is formed, wherein the liquid crystal cells comprise at least one fill opening.

In a first step a) of the method at least one liquid crystal cell is placed inside a vacuum chamber. In a subsequent step b) the vacuum chamber is evacuated. After evacuation has been completed, the at least one fill opening of the at least one liquid crystal cell is contacted with the medium comprising at least one liquid crystalline material in a step c). In a subsequent step d) the pressure in the vacuum chamber is raised, wherein the rising pressure in the vacuum chamber causes the medium to fill the cavity inside the at least one liquid crystal cell.

In the proposed method a signal indicating the amount of oxygen remaining inside the vacuum chamber is provided by means of an oxygen sensor mounted inside the vacuum chamber and completion of the evacuation of the vacuum chamber is determined based on said signal.

The medium comprising at least one liquid crystalline material is preferably in a liquid state. The medium may comprise a single liquid crystalline material or a mixture of two or more liquid crystalline materials.

The liquid crystal cell is, for example, a liquid crystal cell device suitable for a switchable window. Further, the liquid crystal cell may be a cell suitable for a liquid crystal display (LCD). The substrates are preferably of rectangular shape wherein the length of the sides of the rectangle may be in the range of from 20 cm to 500 cm, especially preferred in the range of from 50 cm to 400 cm and most preferred in the range of from 100 cm to 250 cm. Substrates can be of arbitrary shape, wherein rectangular shape is the most common shape.

The substrates are preferably optically transparent. The two substrates may be independently selected from a polymer or a glass. Suitable glass substrates include, for example, float glass, downdraw glass, chemically or heat treated toughened glass, borosilicate glass and aluminosilicate glass.

Suitable polymer substrates include, for example, polyethylene terephthalate (PET), polyethylene naphthalate (PEN), polyvinylbutyral (PVB), polymethyl methacrylate (PMMA), polycarbonate (PC), polyimide (PI), COP (cyclic olefin polymers) and cellulose triacetate (TAC).

The two substrates are arranged as a cell wherein a gap is formed by the two substrates. The size of the gap is preferably from 1 μm to 300 μm, preferably from 3 μm to 100 μm and more preferably from 5 μm to 100 μm, and most preferably from 10 μm to 50 μm. The cell is usually sealed by means of glue lines located at or near the edges.

After the cavity has been filed with the medium, the at least one fill opening (or fill port) is sealed and the liquid crystal cell is completed.

It is possible to process only a single cell at one time. Preferably two or more liquid crystal cells are processed simultaneously in the same vacuum chamber. Preferably, between 2 and 200 liquid crystal cells and more preferably, between 10 and 120 liquid crystal may be processed simultaneously. For example, four liquid crystal cells are processed at the same time. The optimum number of liquid crystal cells which are processed simultaneously in the same vacuum chamber may depend on the size of the liquid crystal cells.

Preferably, the evacuation of the vacuum chamber is considered to be completed if the signal indicating the amount of oxygen inside the vacuum chamber is below a predetermined threshold.

In order to determine the threshold, empirical studies may be conducted. For example, several test runs may be performed wherein the signal of the oxygen sensor is recorded and the time used for evacuating the vacuum chamber is reduced for each subsequent run. The threshold is then set to the recorded sensor value measured after completion of the evacuation for the test run which produced a correctly filled liquid crystal cell in the least amount of time. Also, the threshold may be determined by comparing the signal indicating the amount of oxygen inside the vacuum chamber to a signal of a pressure sensor mounted inside the vacuum chamber.

Alternatively or additionally to providing a predetermined threshold, the derivative of the signal may be determined and the derivative may be compared to a predetermined threshold. The derivative of the signal indicates a slope or speed of change of the signal. Preferably, the evacuation of the vacuum chamber is considered to be completed when a steep slope is detected.

If a pressure sensor is used to observe the evacuation of the vacuum chamber, the signal of the pressure sensor drops rapidly at the beginning of the evacuation process and then converges slowly towards an end pressure of the vacuum pump. Air trapped inside the cavity of the liquid crystal cells will only slowly leak out of the cavities. Completion of the evacuation process wherein essentially all air has been removed from the cavities is hardly visible in a signal of a pressure sensor.

Advantageously, the signal of the preferred oxygen sensor experiences a rapid change when essentially all air and thus oxygen has been evacuated from the cavities of the liquid crystal cells. The change in the signal provided by the oxygen sensor is easy to detect and provides a safe and reliable indication that the filling process may now continue.

Thus, by use of the proposed method it is not required to add safety margins wherein evacuation is continued for a certain amount of time even after a certain threshold pressure has been reached. This allows for more rapid process cycles as unnecessary waiting times are avoided.

When the vacuum chamber and thus the liquid crystal cells are evacuated, there are two gas flow regimes to be recognized. The first flow regime is a laminar flow regime. After a cross over pressure has been reached, a molecular flow regime is entered.

In the first flow regime, it is difficult to establish large pressure differences inside the cell: the pump down mechanism via the fill openings is a gradual one. A careful balance must be maintained between the pressure inside the cell and the vacuum chamber. As it is not possible to directly control the pressure inside the cell, the pressure of the vacuum chamber must be controlled such that a force exerted onto the substrate caused by a pressure difference between the chamber pressure and the cell pressure is not exceeding maximum load or maximum allowed stress level inside the substrate material.

The conductance in laminar flow region is characterized by the average pressure difference over the filling ports. As the absolute pressure inside the vacuum chamber is lowered, the pressure difference between the cell and the vacuum chamber is also lowered, hence the conductance becomes smaller and smaller.

Once the pressure (or rather the molecular mean free path) is in the order of the spacing of the cell, a cross over point is reached from laminar flow to the molecular flow region. The conductance in the molecular flow region is pressure independent.

Since the physical first part of the cell which enters into the molecular flow region, are the filling ports, a pressure difference now can be generated between the top part of the cell and the filling ports. The pressure difference between the chamber and cell is now always lower than the maximum allowed stress level inside the substrate material. Pumping the vacuurn chamber can now be done at maximum speed/capacity of the vacuum pump.

This means that the residual air between the filling ports and the other parts inside the cell will progressively flow out of the cell, until a level is reached wherein essentially all air is removed by pumping through the filling ports. On that moment, the oxygen signal which is measured in the vacuum chamber (and which was determined by the residual gas flow from the air inside the cell) is seen to be dropping steeply. This steep drop is an indication that the cell is pumped down to an acceptable level to start the filling process with the medium.

In order to avoid large pressure difference between the inside of a liquid crystal cell and the vacuum chamber during evacuation, it is preferred to perform a primary evacuation in a pressure range of ambient pressure to an intermediate pressure in the range of from 10 mbar to 50 mbar. After completion of the primary evacuation, it is preferred to perform a secondary evacuation. During primary evacuation, a vacuum pump is operated at reduced capacity and during secondary evacuation the vacuum pump is operated at full capacity.

By performing such a controlled evacuation the maximum stress exerted onto the substrates is limited to a safe value. Optical distortions of the final liquid crystal cell due to stress in the substrates is advantageously avoided.

Vacuum pumps such as rotary vane pumps, cryopumps or scroll pumps may be used with and without combination with turbomolecular pumps.

For successful filing of the liquid crystal cells the pressure inside the vacuum chamber should not be too low in order to avoid degradation of the liquid crystals in the medium. Preferably, the pressure is greater or equal to 1.0*10⁻⁴ mbar. Thus, it is preferred that the thresholds used in conjunction with the signal of the oxygen sensor is chosen such that after the evacuation is considered to be completed, the pressure in the vacuum chamber is greater than or equal to 1.0*10⁻⁴ mbar.

The medium for filling the at least one liquid crystal cell is preferably provided in a tray which is connected to a reservoir. The tray is preferably located inside the vacuum chamber and the at least one liquid crystal cell is arranged such that the fill opening is located at the bottom so that the fill opening may be contacted with the medium inside the tray by submerging the fill opening the medium by lowering the liquid crystal cell, by raising the tray and/or by adjusting the fill level of the medium in the tray.

After the at least one fill opening of the at least one liquid crystal cell has been contacted with the medium, the pressure inside the chamber is raised. The rising pressure pushes the medium into the cavity between the substrates and the cells are filled.

Preferably, nitrogen gas or ultra clean compressed air is introduced into the vacuum chamber for raising the pressure inside the vacuum chamber.

A further aspect of the invention is providing an apparatus for filling liquid crystal cells with a medium. The apparatus comprises a vacuum chamber, a tray for holding the medium, the tray being located inside the vacuum chamber, means for submerging a fill opening of at least one liquid crystal cell in the medium, a vacuum pump, an oxygen sensor and a control unit.

The control unit is preferably adapted and configured to carry out the steps of one of the described methods for filling liquid crystal cells with a medium. Thus, features described with respect to the method apply to the apparatus and vice versa features described with respect to the apparatus apply to the methods.

The vacuum chamber may be divided into an upper chamber and a lower chamber which may be separated by means of a gate. In such a setup, the liquid crystal cells to be filled are arranged in the upper chamber and the tray comprising the medium is arranged in the lower chamber. The upper chamber has a smaller volume than the total combined volume of the vacuum chamber which makes it easier to perform a controlled evacuation of the upper chamber and thus to evacuate the cavities inside the liquid crystal cells. After evacuation of both the upper chamber and the lower chamber is complete, the gate is opened.

The apparatus may make use of one or more vacuum pumps such as rotary vane pumps, cryopumps or scroll pumps which may be used with and without combination with one or more turbomolecular pumps.

The oxygen sensor is preferably based on a potentiometric zirconia solid electrolyte cell. Preferably, the oxygen sensor produces a signal which indicates the partial pressure of oxygen. The oxygen sensor is connected to the control unit which controls the evacuation of the vacuum chamber in response to the signal provided by the oxygen sensor.

Preferably, the means for submerging a fill opening are constructed as a mount which holds the at least one liquid crystal cell such that the fill opening is located inside the tray and means for controlling a fill level of the medium inside the tray.

Preferably, the means for submerging a fill opening of a liquid crystal cell are constructed as a lift which is configured to lower the at least one liquid crystal cell into the tray.

Alternatively or additionally, the means for submerging a fill opening of a liquid crystal cell are constructed as a lift which is configured to raise the tray such that the fill opening is located inside the tray.

The apparatus may further comprise a reservoir for supplying the medium to the tray. A valve may be used to control the supply of the medium.

Preferably, the apparatus comprises a vent valve which is configured to introduce air, nitrogen and/or ultraclean compressed air in a controlled manner into the vacuum chamber in order to raise the pressure. Preferably, an inert gas such as nitrogen is used. The vent valve may be connected to a supply for pure nitrogen or ultraclean compressed air.

The apparatus may comprise a pressure sensor for measuring the pressure inside the vacuum chamber. The pressure sensor may be used for controlling the rate at which the vacuum chamber is evacuated by the vacuum pump.

A further aspect of the invention relates to the use of an oxygen sensor in a process for filling liquid crystal cells with a medium comprising at least one liquid crystalline material. The oxygen sensor is preferably based on a potentiometric zirconia solid electrolyte cell.

### BRIEF DESCRIPTION OF THE DRAWINGS

The drawings show:

FIG. 1a a first embodiment of the apparatus for filing liquid crystal cells prior to submerging a fill opening in a medium comprising at least one liquid crystalline material,

FIG. 1b the first embodiment of the apparatus after submerging the fill opening in the medium,

FIG. 2a a second embodiment of the apparatus prior to submerging the fill opening in the medium,

FIG. 2b the second embodiment of the apparatus after submerging the fill opening in the medium,

FIG. 3 a diagram illustrating a controlled two-stage evacuation,

FIG. 4 a diagram showing pressure and oxygen signals for a filling process using the first embodiment of the apparatus,

FIG. 5 a diagram showing pressure and oxygen signals for a filling process using the second embodiment of the apparatus,

FIG. 6a a diagram showing the pressure for different cells, and

FIG. 6b a diagram showing the oxygen level for different cells.

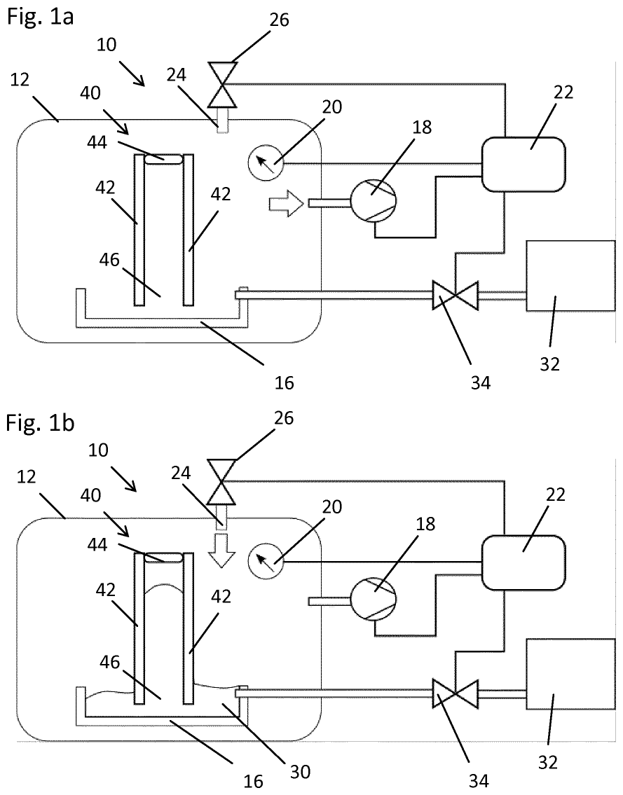

FIGS. 1a and 1b schematically show a first embodiment of an apparatus 10 for filling liquid crystal cells 40 with a medium 30. The apparatus 10 comprises a vacuum chamber 12 and a tray 16 for providing the medium 30 is located inside the vacuum chamber 12.

The tray 16 is connected to a reservoir which in the depicted example is a medium storage 32. A medium valve 34 is used to control supply of the medium 30 from the medium storage 32 to the tray 16.

The vacuum chamber 12 is connected to a vacuum pump 18 for evacuation the vacuum chamber 12. Both the vacuum pump 18 as well as the medium valve 34 are controlled by a control unit 22.

Preferably, evacuation of the vacuum chamber 12 is performed in two stages. In a primary evacuation stage, the vacuum pump 18 is operated at reduced power, for example by partially closing a valve for regulating pumping power (a regulating valve is not displayed in the drawings). After an ambient pressure inside vacuum chamber 12 has been reduced to below about 50 mbar, the vacuum pump 18 is operated at full power for the second evacuation stage.

An oxygen sensor 20 is arranged within the vacuum chamber 12 and is also connected to the control unit 22. Further, it is possible to arrange a pressure sensor, which is not displayed in the drawings, within the vacuum chamber 12 and this pressure sensor may also be connected to the control unit 22. A vent 24 with a vent valve 26, which is connected to the control unit 22, may be used to raise the pressure inside the vacuum chamber 12 in a controlled manner.

In the situation depicted in FIG. 1a, an empty liquid crystal cell 40 which is formed by two substrates 42 and a seal 44 is located in the vacuum chamber 12. A fill opening 46 is located at the bottom of the liquid crystal cell 40. The liquid crystal cell 40 is arranged such that the fill opening 46 is located below a maximum fill level of the tray 16.

In FIG. 1a, the vent valve 26 is closed and the vacuum pump 18 is used to evacuate the vacuum chamber 12. The completion of the evacuation is indicated by a signal provided by the oxygen sensor 20. Upon completion of the evacuation, the control unit 22 stops the vacuum pump 18 and begins the filling process by opening the medium valve 34 so that the medium 30 flows from the medium storage 32 into the tray 16. By filling the tray 16, the fill opening 46 is submerged into the medium 30 as depicted in FIG. 1b.

After submerging the fill opening 46 into the medium 30, the control unit 22 opens the vent valve 26 so that, for example, nitrogen may enter the vacuum chamber 12 so that the pressure inside the vacuum chamber 12 rises.

As illustrated in FIG. 1b, the rising pressure inside the vacuum chamber 12 pushes the medium 30 into the liquid crystal cell 40. After filling of the liquid crystal cell 40 is complete, the fill opening 46 is sealed in a subsequent process step and the liquid crystal cell 40 is completed.

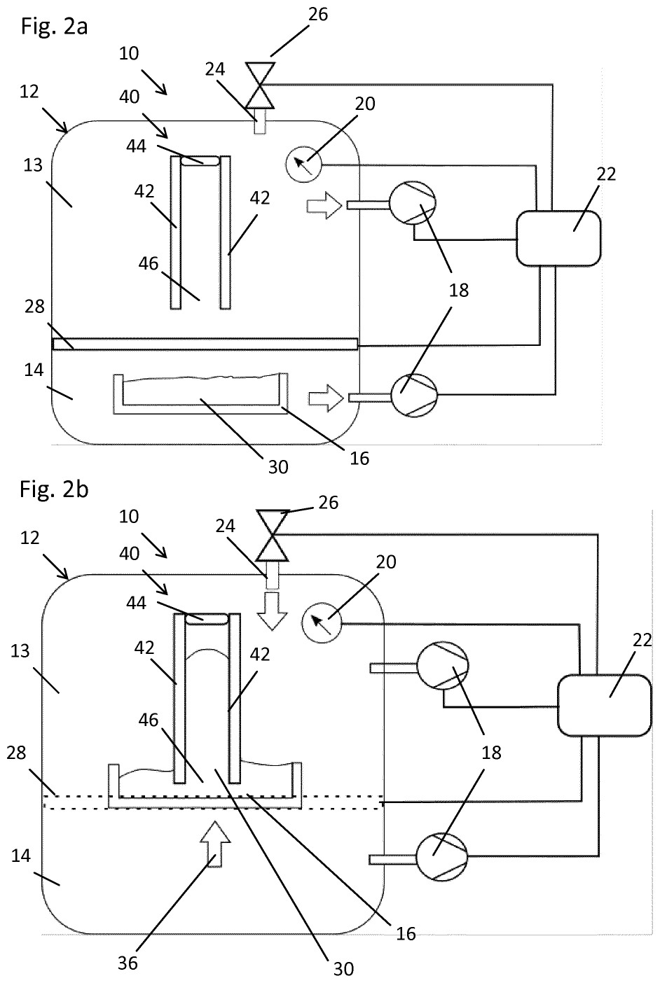

FIGS. 2a and 2b schematically depict a second embodiment of the apparatus 10 for filling liquid crystal cells 40 with a medium 30.

The vacuum chamber 12 of the apparatus 10 of the second embodiment is divided into an upper chamber 13 and a lower chamber 14 by means of a gate 28. Each of the two chambers 13, 14 is connected to a vacuum pump 18. Both vacuum pumps 18 are connected to the control unit 22. The oxygen sensor 20 which is used to monitor evacuation of the liquid crystal cell 40 is located in the upper chamber 13.

In the situation depicted in FIG. 2a, the empty liquid crystal cell 40 is located in the upper chamber 13. The tray 16 which is already filled with the medium 30 is located in the lower chamber 14 and both chambers 13 and 14 are being evacuated.

The gate 28 may be opened in order to connect the upper chamber 13 and the lower chamber 14 and to allow the fill opening 46 of the liquid crystal cell 40. By means of the division of the vacuum chamber 12, the volume surrounding the liquid crystal cell 40 is reduced which facilities evacuation of the residual air which may be trapped inside the cavity of the liquid crystal cell 40.

The gate 28 is opened when the oxygen sensor 20 indicates that the evacuation of the upper chamber 13 is complete. Preferably, a two stage evacuation is performed in the upper chamber 13 as described with respect to the first embodiment of FIGS. 1a and 1b.

In order to contact the fill opening 46 of the liquid crystal cell 40, which is located at the bottom, with the medium 30, the tray 16 holding the medium 30 is raised by means of a lifting mechanism. Reference numeral 36 indicates the upward movement of the tray 16.

After the fill opening 46 has been contacted with the medium 30, the control unit 22 opens the vent valve 26 so that, for example, nitrogen may enter the vacuum chamber 12 so that the pressure inside the vacuum chamber 12 rises.

As illustrated in FIG. 2b, the rising pressure inside the vacuum chamber 12 pushes the medium 30 into the liquid crystal cell 40. After filling of the liquid crystal cell 40 is complete, the fill opening 46 is sealed in a subsequent process step and the liquid crystal cell 40 is completed.

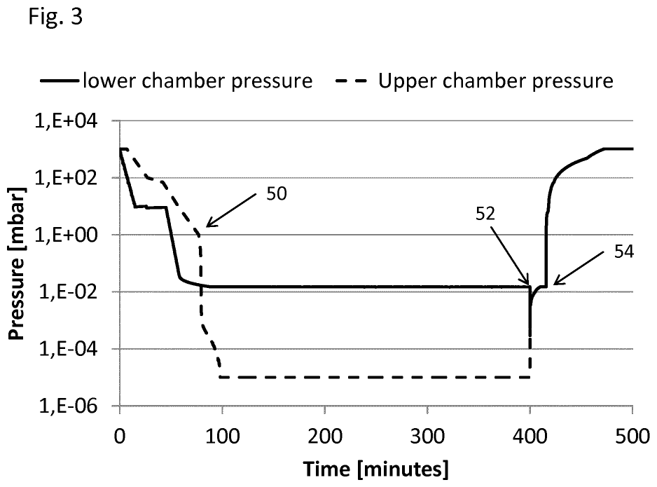

The diagram of FIG. 3 shows the pressure inside the upper chamber 13 and the lower chamber 14 of the second embodiment of the apparatus 10 as described with respect to FIGS. 2a and 2b. In order to observe the pressure, further pressure sensors are arranged in the upper chamber 13 and the lower chamber 14. The x-axis of the diagram indicates the elapsed time in minutes and the y-axis indicates the measured pressure in mbar.

As described above, evacuation of the upper vacuum chamber 13 which holds the liquid crystal cell 40 is preferably performed in two stages. In the primary evacuation stage, the vacuum pump 18 is operated at reduced power. After an ambient pressure inside vacuum chamber 12 has been reduced to below about 50 mbar, the vacuum pump 18 is operated at full power for the second evacuation stage. The change from the primary evacuation stage to the secondary evacuation stage is visible in the diagram of FIG. 3 where at point 50 the slope of the pressure curve becomes steeper.

At point 52 as indicated in FIG. 3, the gate 28 is opened and thus the upper chamber 13 and the lower chamber 14 become connected. This causes pressure equalization between the two chambers 13 and 14.

At point 54, the vent valve 26 is opened and the pressure in the connected chambers 13 and 14 rises.

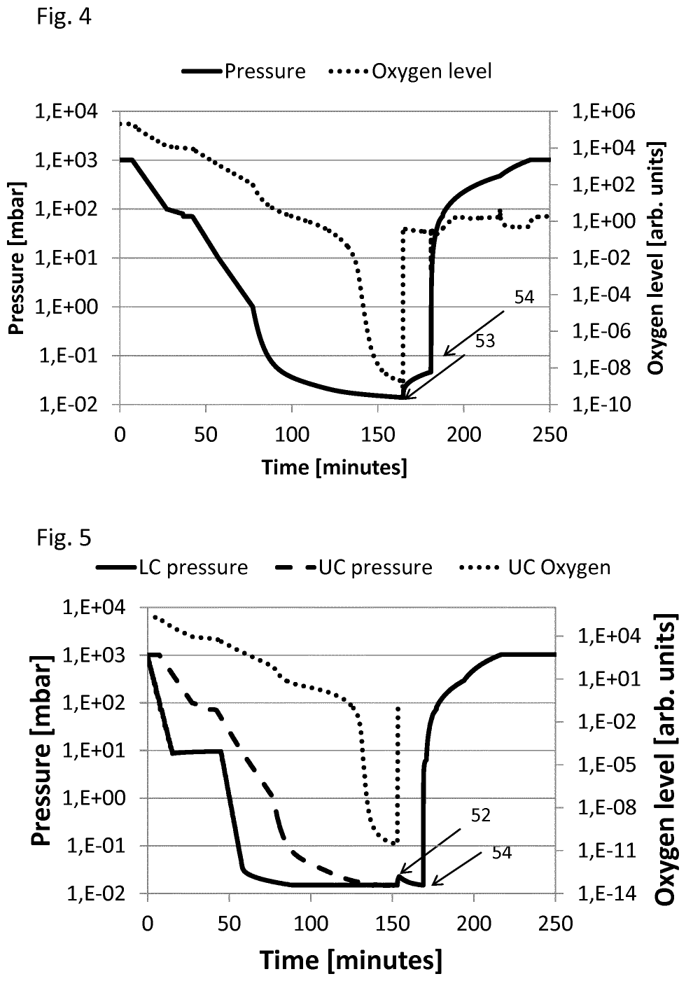

The diagram of FIG. 4 shows recorded signals of the oxygen sensor 20 and of an additional pressure sensor which are arranged in the vacuum chamber 12 of the apparatus 10 of the first embodiment as shown in FIGS. 1a and 1b. The x-axis of the diagram indicates the elapsed time in minutes. The left y-axis indicates the measured pressure in mbar and the right y-axis indicates the oxygen level in arbitrary units.

During the evacuation of the vacuum chamber 12, the pressure drops rapidly at first and then begins to converge towards the final pressure of the vacuum pump 18. Even so the chamber 12 itself is evacuated rapidly, the air trapped inside the liquid crystal cell 40 only slowly leaks out through the fill opening 46. The completion of the evacuation, wherein essentially all air is evacuated from the cavity of the liquid crystal cell 40 cannot safely be determined from the signal of the pressure sensor as only small and gradual changes are observed.

The oxygen level indicated by the oxygen sensor 20, however, experiences a rapid drop which may by easily identified and indicates completion of the evacuation process. At point 53, the evacuation is considered to be complete. The vacuum pump 18 is switched off and the fill opening 46 of the liquid crystal cell 40 is submerged in the medium 30. In order to ensure that the liquid crystal cell 40 is submerged in a calm and stable medium 30, a waiting time is added before the vent step is started. At point 54, the vent valve 26 is opened and the filling process is started.

The diagram of FIG. 5 shows recorded signals of the oxygen sensor 20 and of additional pressure sensors which are arranged in the upper vacuum chamber 13 and the lower vacuum chamber 14 of the apparatus 10 of the second embodiment as shown in FIGS. 2a and 2b. The x-axis of the diagram indicates the elapsed time in minutes. The left y-axis indicates the measured pressure in mbar and the right y-axis indicates the oxygen level in arbitrary units.

During the evacuation of the vacuum chambers 13 and 14, the pressure drops rapidly at first and then begins to converge towards the final pressure of the vacuum pump 18. Because the air which is trapped inside the cavity of the liquid crystal cell 40 only slowly leaks out through the fill opening 46, the pressure of the upper chamber drops slower than the pressure of the lower chamber 14. The completion of evacuation, wherein essentially all air is evacuated from the cavity of the liquid crystal cell 40 cannot safely be determined from the signal of the pressure sensor as only small and gradual changes are observed.

The oxygen level indicated by the oxygen sensor 20, however, experiences a rapid drop which may by easily identified and indicates completion of the evacuation process. At point 52, the gate 28 is opened so that the upper chamber 13 and the lower chamber 14 become connected. At point 54, the vacuum pump 18 is switched off, the vent valve 26 is opened and the filling process is started.

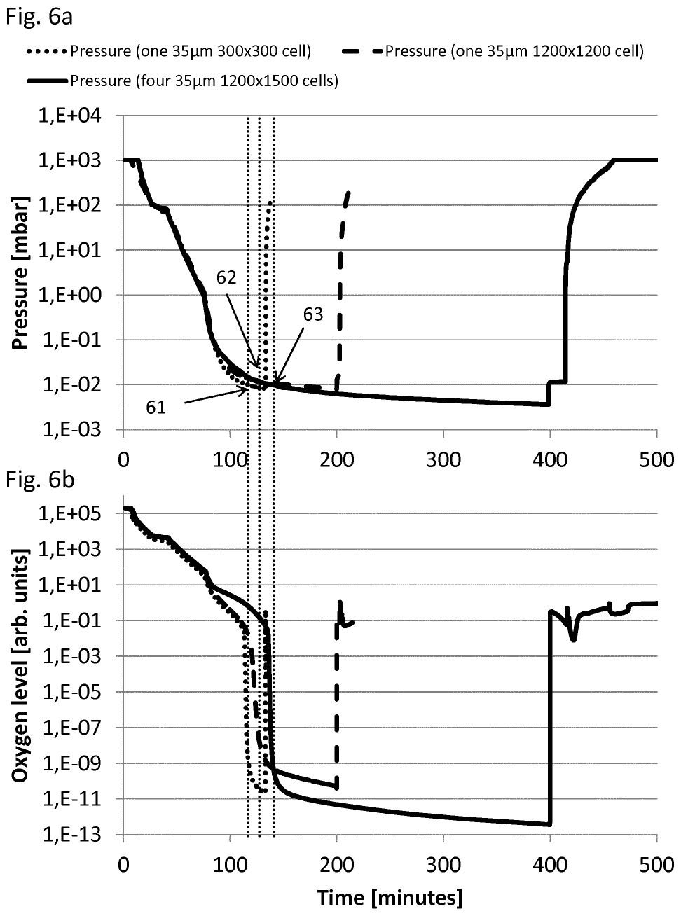

FIG. 6a shows a diagram wherein the pressure during evacuation of the vacuum chamber 12 of the apparatus 10 of the first embodiment has been recorded for different types and numbers of liquid crystal cells 40. FIG. 6b shows a diagram with the corresponding oxygen levels which have been recorded by the oxygen sensor 20. The x-axis of the diagrams of FIGS. 6a and 6b indicates the elapsed time in minutes. The y-axis of FIG. 6a indicates the measured pressure in mbar and the y-axis of FIG. 6b indicates the oxygen level in arbitrary units.

A first curve, which is shown as dotted line, indicates the data recorded for one cell with substrate sizes of 300 mm×300 mm and a cell gap of 35 μm. A second curve, which is shown as dashed line, indicates the data recorded for one cell with substrate sizes of 1200 mm×1200 mm and a cell gap of 35 μm. A solid third curve indicates the data recorded for four cells with substrate sizes of 1200 mm×1500 mm and a cell gap of 35 μm.

The completion of the evacuation process is indicated by the rapid drop of the oxygen level indicated by the oxygen sensor 20. As shown by the three points 61, 62 and 63, the corresponding recorded pressure levels are slowly changing and do not provide a clear indication which may be used to determine when evacuation has been completed.

In a conventional process for filling of a single cell of size 300 mm×300 mm, the evacuation of the vacuum chamber 12 is continued until about 130 minutes have lapsed in order to ensure complete evacuation of the cavities of the cells. With the inventive process evacuation is considered to be complete after about 114 minutes as indicated by a rapid drop of the oxygen level indicated by the oxygen sensor 20 at the first point 61.

In a conventional process for filling of a single cell of size 1200 mm×1200 mm, the evacuation of the vacuum chamber 12 is continued until about 140 minutes have lapsed in order to ensure complete evacuation of the cavities of the cells. With the inventive process evacuation is considered to be complete after about 125 minutes as indicated by a rapid drop of the oxygen level indicated by the oxygen sensor 20 at the second point 62.

In a conventional process for filling of four cells of size 1200 mm×1500 mm, the evacuation of the vacuum chamber 12 is continued until about 400 minutes have lapsed in order to ensure complete evacuation of the cavities of the cells. With the inventive process evacuation is considered to be complete after about 140 minutes as indicated by a rapid drop of the oxygen level indicated by the oxygen sensor 20 at the third point 63.

Thus, the inventive method provides a safe way to determine completion of evacuation without having to rely on safety margins and experience of the operator. By reducing unnecessary time delays the required time for a complete process cycle is advantageously reduced.

### LIST OF REFERENCE NUMERALS

10 apparatus
12 vacuum chamber
13 upper chamber
14 lower chamber
16 tray
18 vacuum pump
20 oxygen sensor
22 control unit
24 vent
26 vent valve
28 gate
30 medium
32 medium storage tank
34 medium valve
36 lifting motion
40 liquid crystal cell
42 substrate
44 seal
46 fill opening
50 point (activation of turbo pump)
52 point (opening of gate)
53 point (waiting)
54 point begin filling
61 point (pressure ok)
62 point (pressure ok)
63 point (pressure ok)

1. Method for filling liquid crystal cells (40) with a medium (30) comprising at least one liquid crystalline material, the liquid crystal cells (40) comprising two substrates (42) joined together with a peripheral seal (44) so that a cavity is formed, wherein the liquid crystal cells (40) comprise at least one fill opening (46), the method comprising the steps of
a) placing at least one liquid crystal cell (40) inside a vacuum chamber (12),
b) evacuating the vacuum chamber (12),
c) contacting the at least one fill opening (46) with the medium (30) comprising at least one liquid crystalline material after evacuation of the vacuum chamber (12) has been completed, and
d) raising the pressure in the vacuum chamber (12), wherein the rising pressure in the vacuum chamber (12) causes the medium (30) to fill the cavity inside the at least one liquid crystal cell (40),
characterized in that a signal indicating the amount of oxygen remaining inside the vacuum chamber (12) is provided by means of an oxygen sensor (20) mounted inside the vacuum chamber (12) and completion of the evacuation of the vacuum chamber (12) is determined based on said signal.

2. Method according to claim 1, wherein the evacuation of the vacuum chamber (12) is considered to be completed if the signal indicating the amount of oxygen inside the vacuum chamber (12) is below a predetermined threshold.

3. Method according to claim 2, wherein the threshold is determined by comparing the signal indicating the amount of oxygen inside the vacuum chamber (12) to a signal of a pressure sensor mounted inside the vacuum chamber (12).

4. Method according to claim 1, wherein a primary evacuation is performed in a pressure range of ambient pressure to an intermediate pressure in the range of from 10 mbar to 50 mbar and a secondary evacuation is performed after completion of the primary evacuation, wherein a vacuum pump (18) is operated at reduced capacity during the primary evacuation and the vacuum pump (18) is operated at full capacity during secondary evacuation.

5. Method according to claim 1, wherein the pressure inside the vacuum chamber (12) after the evacuation is considered to be completed is greater than or equal to 1.0*10⁻⁴ mbar.

6. Method according to claim 1, wherein the medium (30) is provided in a tray (16) located inside the vacuum chamber (12), the at least one liquid crystal cell (40) being arranged such that the fill opening (46) is at the bottom, the fill opening (46) being contacted with the medium (30) by submerging the fill opening (46) in the medium (30) by lowering the liquid crystal cell (40) or raising the tray (16).

7. Method according to claim 1, wherein after the medium (30) has filled the liquid crystal cell (40), the at least one fill opening (46) is sealed.

8. Method according to claim 1, wherein two or more liquid crystal cells (40) are processed simultaneously in the same vacuum chamber (12).

9. Method according to claim 1, wherein nitrogen gas or ultra clean compressed air is introduced into the vacuum chamber (12) for raising the pressure inside the vacuum chamber (12).

10. Apparatus (10) for filling liquid crystal cells (40) with a medium (30) comprising at least one liquid crystalline material, the apparatus (10) comprising:
a vacuum chamber (12),
a tray (16) for holding the medium (30), the tray (16) being located inside the vacuum chamber (12),
means for submerging a fill opening (46) of at least one liquid crystal cell (40) in the medium (30),
a vacuum pump (18),
an oxygen sensor (20),
a control unit (22),
wherein the control unit (22) is adapted to carry out the steps of a method according to claim 1.

11. Apparatus (10) according to claim 10, wherein the oxygen sensor (20) is based on a potentiometric zirconia solid electrolyte cell.

12. Apparatus (10) according to claim 10, wherein the means for submerging a fill opening (46) are constructed as a mount which holds the at least one liquid crystal cell (40) such that the fill opening (46) is located inside the tray (16) and means for controlling a fill level of the medium (30) inside the tray (16).

13. Apparatus (10) according to claim 10, wherein the means for submerging a fill opening (46) are constructed as a lift which is configured to lower the at least one liquid crystal cell (40) into the tray (16).

14. Apparatus (10) according to claim 10, wherein the means for submerging a fill opening (46) are constructed as a lift which is configured to raise the tray (16) such that the fill opening (46) is located inside the tray (16).

15. (canceled)
